(19) United States
(12) Patent Application Publication
(10) Pub. No.: US 2006/0208373 A1
(43) Pub. Date: Sep. 21, 2006

(54) Device and method for humidifying hydrogen

(75) Inventor: Gerhard Berger, Ebersbach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/376,353

(22) Filed: Mar. 15, 2006

(30) Foreign Application Priority Data
Mar. 16, 2005 (DE) DE 102005012071.7

(51) Int. Cl. B01D 47/00

(52) U.S. Cl. 261/100

(57) ABSTRACT

A device and a method are used for humidifying a hydrogen stream supplied to an anode chamber of a fuel cell. The hydrogen is humidified via water-permeable membranes. The residual hydrogen removed from the anode chamber, which humidifies the hydrogen flowing to the anode via the membranes, is used as the moisture carrier. Porous membranes are used as membranes.

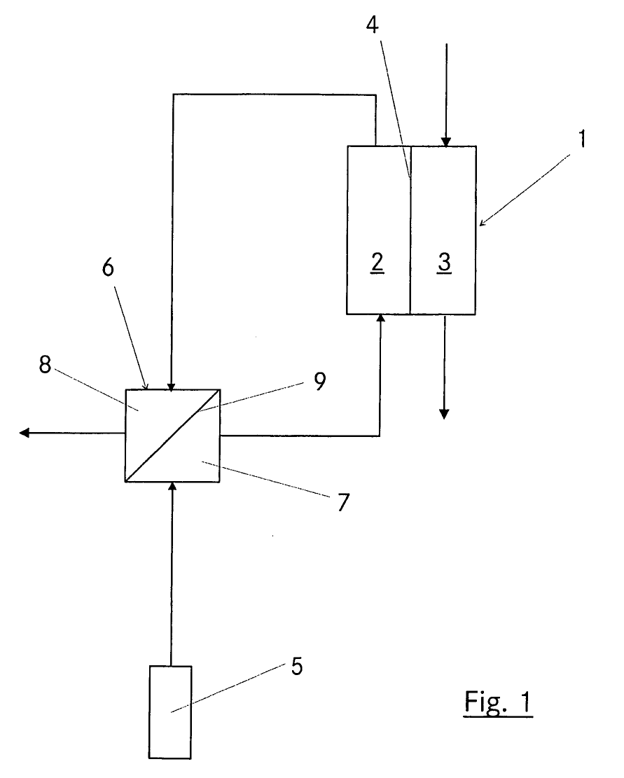

Priority is claimed to German Patent Application DE 10 2005 012 071.7, filed Mar. 16, 2005, the entire disclosure of which is being incorporated by reference herein.

The present invention relates to a device for humidifying hydrogen supplied to an anode chamber of a fuel cell of the type having water-permeable membranes, a chamber through which hydrogen supplied to the anode chamber flows being separated from a chamber through which excess hydrogen from the anode chamber flows by the membranes. Furthermore, the present invention relates to a method for humidifying hydrogen supplied to an anode chamber of a fuel cell, the hydrogen supplied to the anode chamber being humidified by excess hydrogen flowing from the anode chamber through the membranes.

### BACKGROUND

It is known from DE 102 02 471 A1 that gases supplied to a fuel cell can be humidified by the waste gases flowing from the fuel cell via membrane modules, in particular hollow fiber membrane modules. Membranes of this type for humidifying hydrogen supplied to the anode chamber of a fuel cell are designed, for example, in DE 102 14 078 A1, as membranes which are impermeable to the particular gas stream and permeable only to water in the vapor form.

The disadvantage of such a method for humidifying hydrogen flowing to a fuel cell, such as that described in DE 102 02 471 A1, is that the dew point needed for reliable operation of the fuel cell, and this means for sufficient humidification of the polymer electrolyte membranes, is not achieved in this way using the moisture from the fuel cell waste gas. Therefore, in the above-mentioned document, additional water injection is provided to achieve the required humidity in the hydrogen stream flowing to the fuel cell, in particular under full load of the fuel cell.

### SUMMARY OF THE INVENTION

An object of the present invention is to avoid these disadvantages and to provide a device and a method which make it possible to transfer a sufficiently high amount of water from the gas stream flowing from the anode chamber of a fuel cell to the gas stream flowing to the anode chamber of the fuel cell.

According to the present invention, a porous membrane is used. Porous membranes as defined in the present invention are to be understood as microporous membranes whose pore system is filled with liquid water. They thus also allow, in addition to water transfer via permeation through the membrane, water transfer through the porous system of the membrane.

Since the fuel cell is typically operated using a slight excess of hydrogen, approximately 10% to 20% of the hydrogen needed in the fuel cell, the volume of the anode waste gas is low compared to the volume of hydrogen supplied to the anode. A two-phase stream of hydrogen saturated with water vapor and liquid water is thus established in the anode waste gas in almost all operating states of the fuel cell. Unlike the previously customary non-porous membranes, the membrane according to the present invention allows, in the case of such a mixture, a relatively high amount of water to be exchanged via transfer from the waste gas flow of the anode through the porous membrane into its hydrogen inflow. The water transfer rate is thus considerably increased compared to non-porous membranes.

Due to the fact that hydrogen is humidified here using only moist residual hydrogen from the anode chamber in contrast to humidifying methods using the waste gas of the fuel cell, the permeability of the membrane has a subordinate role. If hydrogen passes through the membrane in addition to moisture, it makes no difference, since a hydrogen/water (vapor) mixture exists on both sides of the membrane.

According to an advantageous embodiment of the method according to the present invention, it becomes unnecessary to handle liquid water, since a sufficiently large amount of water may be exchanged through the porous membrane. Therefore no liquid water has to be injected into the hydrogen flowing to the fuel cell. High-purity water needed for humidification no longer has to be provided, for example, via a complex condensation process or the like, be kept clean, or be inconveniently handled at sub-freezing temperatures.

The device according to the present invention and the method according to the present invention are therefore simple and sturdy, having relatively few components. They are therefore well-suited for use in fuel cells in mobile systems such as motor vehicles, for example.

### BRIEF DESCRIPTION OF THE DRAWINGS

Further advantageous embodiments of the present invention are described in the exemplary embodiment which is elucidated in greater detail below with reference to the drawing, without being limited thereto.

The sole figure shows a schematic representation of the device according to the present invention.

### DETAILED DESCRIPTION

The sole appended figure schematically shows a fuel cell 1. This fuel cell 1 is typically designed as a stack of a plurality of individual cells, i.e., as a fuel cell stack. Such a fuel cell 1 has, as is known, an anode chamber 2 and a cathode chamber 3. Anode chamber 2 is separated from cathode chamber 3 by a proton-exchange membrane (PEM) 4 embedded in a membrane electrode system (MES). The proton-exchange membrane 4 is typically made of a polymer electrolyte. To ensure the functionality of PEM 4 and prevent damage to PEM 4, it is necessary to keep PEM 4 always sufficiently humid; for this reason, the gases supplied to fuel cell 1 are typically humidified. The gases flowing through cathode chamber 3, typically air, and their conditioning will not be described here in detail, since this is not essential to the object of the present invention.

Hydrogen, which may originate from an accumulator device 5, is supplied to anode chamber 2. The hydrogen originating from accumulator device 5 flows through a device 6 for humidifying it, which will be referred to hereinafter as membrane humidifier 6. Membrane humidifier 6 has two chambers 7 and 8, which are separated by a membrane 9. Membrane 9 is designed in such a way that it is permeable to water, in particular water in its vapor state. To allow passage of a sufficient amount of water through membrane 9, it is designed according to the present invention as a porous membrane 9. Porous membranes 9 as defined in the present invention are to be understood as microporous membranes 9, which allow water transfer through the porous system of membrane 9 in addition to water transfer via permeation through membrane 9.

In a particularly preferred way, porous membranes 9 are designed as hollow fiber membranes, which are combined in a bundle. One chamber 7 is formed by the inside of the hollow fibers, while the other chamber 8 is formed by the volume around the hollow fibers and between the hollow fibers.

In the device according to the sole appended figure, hydrogen coming from accumulator device 5 flows to anode chamber 2 of fuel cell 1 through chamber 7 of membrane humidifier 6. When fuel cell 1 is in operation, the unreacted residual hydrogen picks up the moisture from anode chamber 2 of fuel cell 1. The residual hydrogen/water (vapor) mixture is then conducted to chamber 8 of membrane humidifier 6 and may deliver this moisture through porous membranes 9 to the hydrogen flowing to anode chamber 2 through chamber 7. This hydrogen flowing along membrane 9 as a strip gas picks up the moisture through membrane 9. The residual hydrogen in chamber 8 is dried prior to leaving membrane humidifier 6 again.

The residual hydrogen may be reused indefinitely downstream from device 6, which is not relevant for the present invention. After passing through membrane humidifier 6, it could be supplied to the anode, for example, or supplied to a combustion system, for example, a catalytic combustion system for heating further components, for example, those of a gas generator system, an evaporator, a vehicle heating system, or the like. The residual hydrogen may also be introduced into the cathode chamber for chemically removing the residual hydrogen on the catalytic converter from there to avoid hydrogen in the waste gas.

In order to ensure a sufficient amount of residual hydrogen, so that moisture may be transported from the area of anode chamber 2 and then added to the hydrogen flowing to anode chamber 2, an appropriate excess of hydrogen supplied to fuel cell 1 is necessary. Such an excess typically amounts to 10% to 20% of the hydrogen required in fuel cell 1. In other words, a hydrogen lambda (λ_{H2}) of 1.2 to 1.1 is typically established. The hydrogen originating from the area of accumulator device 5 at a pressure of approximately 2.3 bar has a dew point of approximately 0° C. upstream from membrane humidifier 6. To achieve a desired dew point of approximately 70° C. to 75° C. at full load at a slightly lower pressure in or at the inlet of fuel cell 1, membranes 9 are required in humidifier module 6, which allow highly efficient transfer of a large amount of moisture from the residual hydrogen to the hydrogen flowing to fuel cell 1. Such a high moisture exchange may be achieved and the required dew point may be reached using the porous membranes 9 according to the present invention.

Porous membranes 9 with their pore systems filled with liquid water, whose construction is known per se, allow a high amount of moisture to be passed from the two-phase anode waste gas stream through membrane 9. Furthermore, porous membranes 9 allow the desired dew point (under full load at 2 to 2.3 bar approximately 70° to 75° C.) in the hydrogen flowing to fuel cell 1 to be established via selection of a suitable porosity. With increasing porosity, more water from the gas stream flowing to fuel cell 1 reaches the fuel cell through membrane 9.

The device according to the present invention and the method according to the present invention thus allow hydrogen flowing to a fuel cell 1 to be very efficiently humidified using the residual hydrogen from fuel cell 1, without the necessity of supporting humidification using liquid water, which must be injected, passed through, evaporated, or the like. A very simple, efficient, and, due to the absence of a high-purity water circuit even at temperatures below 0° C., easy-to-use design is thus obtained, which is suitable for any fuel cell system, in particular, however, for mobile fuel cell systems, for example, in motor vehicles.

What is claimed is:

1. A device for humidifying hydrogen supplied to an anode chamber of a fuel cell comprising:
a porous water-permeable membrane,
a first chamber, hydrogen supplied to the anode chamber flowing through the first chamber; and
a second chamber, excess hydrogen from the anode chamber flowing into the second chamber,
the first and second chambers being separated by the membrane.

2. The device as recited in claim 1 wherein the membrane is a hollow-fiber membrane.

3. A method for humidifying hydrogen supplied to the anode chamber of a fuel cell, comprising:
humidifying hydrogen supplied to the anode chamber by exchanging moisture in excess hydrogen flowing from the anode chamber through a porous membrane.

4. The method as recited in claim 3 wherein the hydrogen supplied to the anode chamber is humidified without adding liquid water.

5. The method as recited in claim 3 wherein the porosity of the membrane is selected in such a way that a dew point required for sufficient humidification of a polymer electrolyte membrane of a fuel cell is established.
